(19) United States
(12) Patent Application Publication
(10) Pub. No.: US 2024/0033801 A1
(43) Pub. Date: Feb. 1, 2024

(54) Working Method of Material, and Process Design Computer and Program of the Same

(71) Applicant: Hitachi, Ltd., Chiyoda-ku, Tokyo (JP)

(72) Inventors: Yoshihiko KOBAYASHI, Tokyo (JP); Tetsuya YAGAMI, Tokyo (JP)

(21) Appl. No.: 18/039,572

(22) PCT Filed: Nov. 30, 2021
(86) PCT No.: PCT/JP2021/043925

§ 371 Date: May 31, 2023

(30) Foreign Application Priority Data
Dec. 28, 2020 (JP) 2020-218738

(51) Int. Cl. B21D 22/02

(52) U.S. Cl. CPC B21D 22/02

(57) ABSTRACT

Provided is an identification method of a material characteristic value of a workpiece or a computer to reduce the number of basic tests for acquiring material characteristic values and furthermore to identify the material characteristic values of a larger number of workpieces. The identification method of the material characteristic value of the workpiece or the computer includes: (1) creating, with respect to a first workpiece whose material characteristic value is known, correlation data between the known material characteristic value and a first representative value of the workpiece during working or after working; (2) working on a second workpiece whose material characteristic value is unknown; (3) acquiring a second representative value of the second workpiece during working or after working; and (4) acquiring a material characteristic value of the second workpiece based on the correlation data and the second representative value. Here, the second representative value is a value measured under the same predetermined measurement condition as the first representative value.

### TECHNICAL FIELD

The present invention relates to a working method of a material, and a process design computer and a program of the same.

### BACKGROUND ART

In a working process of a metal, a resin, glass, or the like, occurrence of a defect due to a variation in material characteristic values is a problem. In the working process, for example, in a case of press working in which a plate-shaped workpiece is worked on using a press machine, a deformation amount varies depending on spring back after working due to the variation in the material characteristic values. Accordingly, a shape variation in worked shapes occurs, and a defect occurs. PTL 1 describes a process design and a method for evaluating a process due to the variation in the material characteristic values.

PTL 1 discloses that “stability of spring back is evaluated by: a forming analyzing step (S1) in which forming data of a press formed article is obtained; a step (S2) in which at least one of the data of a physical property and a physical quantity in a part of a region of the press formed article is selected as a control factor and arithmetic processing is performed on the control factor; a step (S3) in which an amount of the spring back is calculated based on the forming data and the forming data after the arithmetic processing; a step (S4) in which S2 and S3 are repeatedly calculated for all selected control factors; a step (S5) in which S1 to S4 are carried out for a forming condition which is different from the above forming condition and an SN ratio of the amount of the spring back corresponding to a difference of the forming condition is calculated for all calculated amounts of the spring back; and a step (S6) in which the stability of the spring back is determined based on the calculated SN ratio”. The term “forming” in PTL 1 is another word of “working” in the present application.

### CITATION LIST

### Patent Literature

PTL 1: JP2011-183417A

### SUMMARY OF INVENTION

### Technical Problem

In the method described in PTL 1, it is assumed that the variation in material characteristic values occurs in a certain range, and a process design and a process stability evaluation considering the variation in the material characteristic values are attempted. However, a variation in actual material characteristic values is unclear, and it is difficult to appropriately design and evaluate a process.

For example, when a variation range of the material characteristic values is assumed to be excessively larger than that of the actual materials, there is a high chance that no process condition satisfying a shape accuracy required for all characteristic values exists. That is, since the variation of the actual materials is unknown, it is unknown to what degree safety should be seen, and thus it is excessively difficult to select an optimal process condition.

It is considered that accurately grasping the variation in the actual material characteristic values contributes to the process design in which occurrence of a shape defect is reduced. For example, even when the variation of the actual material occurs, the process design satisfying a required accuracy of the shape is easy.

The variation in the material characteristic values can be evaluated by increasing the number of tests in a basic test such as ISO 6892. However, in order to accurately evaluate a variation in material characteristic values in a lot and a variation in material characteristic values between different lots, plural basic tests are required. Therefore, it is desired to identify material characteristic values of a larger number of workpieces while reducing the number of tests of the basic test for acquiring the material characteristic values.

### Solution to Problem

In order to solve the above problem, an identification method of a material characteristic value of a workpiece or a computer according to the invention includes:
(1) creating, with respect to a first workpiece whose material characteristic value is known, correlation data between the known material characteristic value and a first representative value of the workpiece during working or after working;
(2) working on a second workpiece whose material characteristic value is unknown;
(3) acquiring a second representative value of the second workpiece during working or after working; and
(4) acquiring a material characteristic value of the second workpiece based on the correlation data and the second representative value. Here, the second representative value is a value measured under the same predetermined measurement condition as the first representative value.

### Advantageous Effects of Invention

According to the invention, it is possible to identify material characteristic values of a larger number of workpieces while reducing the number of tests of a basic test for acquiring the material characteristic values.

Problems, configurations, and effects other than those described above will be clarified by the following description of embodiments.

### BRIEF DESCRIPTION OF DRAWINGS

FIGS. 1A to 1C are perspective views showing a press working process as an example of a working process.

FIG. 2 is a flowchart showing a flow of processing according to Embodiment 1.

FIG. 3 is a flowchart showing a detail of step S210 in the flowchart in FIG. 2 according to Embodiment 1.

FIG. 4 is a table showing an example of correlation data.

FIG. 5 is a table showing variation data of material characteristic values.

FIGS. 6A and 6B are graphs showing a variation in the material characteristic values, in which FIG. 6A shows an example of a material having a small variation in the characteristic values, and FIG. 6B shows an example of a material having a large variation in the characteristic values.

FIGS. 7A and 7B are tables showing a relation among a pressure P, material characteristic values F′ and n′, a measurement value Y1 of a shape measurement position, an absolute value dY1 of a dimension error, an average value p of the dimension error dY1, and a variation index 3σ calculated at three times of a standard deviation of the measurement value Y1, in which FIG. 7A is data obtained by simulation when the pressure is set to 100 Kg, and FIG. 7B is data obtained by simulation when the pressure is set to 150 Kg.

FIG. 8 is a flowchart showing a flow of process condition optimization processing according to Embodiment 3.

FIG. 9 is a flowchart showing a flow of working processing for a workpiece according to Embodiment 3.

FIG. 10 is an overall configuration diagram of a computer system according to Embodiment 4.

FIG. 11 is a front view of an input GUI screen for inputting data according to Embodiment 4.

FIG. 12 is a front view of an output GUI screen for outputting data of a calculation result according to Embodiment 4.

FIG. 13 is a flowchart showing a flow of processing according to Embodiment 4.

### DESCRIPTION OF EMBODIMENTS

Hereinafter, embodiments of the invention will be described in detail with reference to the drawings. In all the drawings showing the embodiments, components having the same function are denoted by the same reference numerals, and repetitive descriptions thereof will be omitted in principle.

However, the invention should not be construed as being limited to the description of the embodiments described below. A person skilled in the art could easily understand that a specific configuration can be changed without departing from the spirit or gist of the invention.

### Embodiment 1

Embodiment 1 shows an example of calculating material characteristic values and a variation thereof according to the invention. In the example as follows, press working and a geometric representative value will be described as an example. A modification will be described later.

### <<Example of Geometric Representative Value in Press Working>>

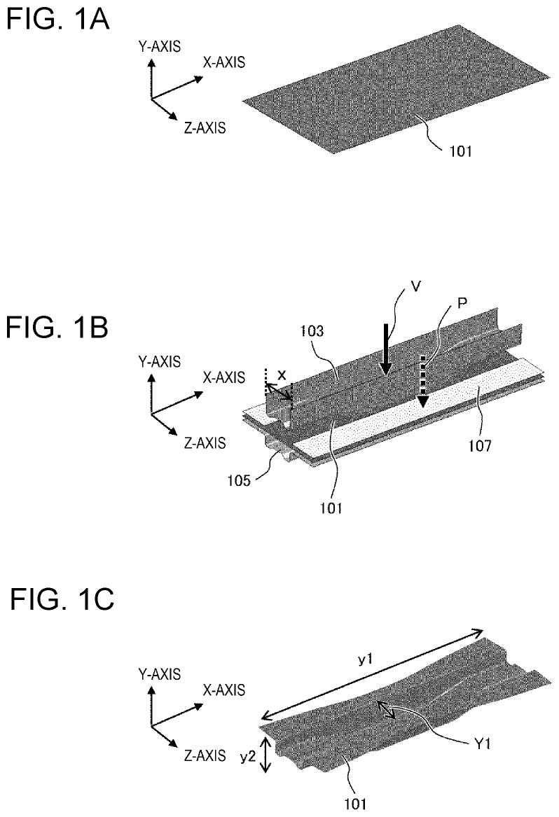

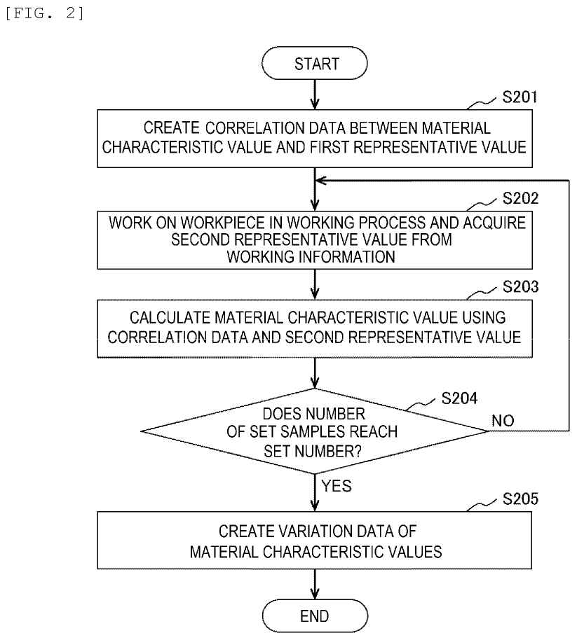

FIGS. 1A to 1C are perspective views showing an example of a press working process. In this drawing, a geometric representative value used for obtaining a material characteristic value will be described. In the following description, a material characteristic value of a workpiece may be simply abbreviated as a characteristic value. FIG. 1A shows the workpiece before working, FIG. 1B shows an overall view of the press working process, and FIG. 1C shows a working shape (after spring back) which is worked on. An actual die has a massive shape, and only a surface in contact with a workpiece 101 is extracted and illustrated for simplification.

In FIG. 1B, the plate-shaped workpiece 101 in FIG. 1A is first sandwiched and fixed between a lower die 105 and a plate presser 107, and an upper die 103 moves downward to perform the press working for the workpiece 101. Here, a pressure of the plate presser 107 is represented by P, and a press speed of the upper die 103 is represented by V. As an example of a shape parameter of the die, a width of the die is x.

After the working is completed, the upper die 103 and the plate presser 107 are removed, and a working shape which is worked on is detached to obtain a working shape of FIG. 1C. However, since a stress is released by removing a force from the die and the plate presser and spring back occurs, a shape of the workpiece 101 in FIG. 1C does not match a shape of the die worked in FIG. 1B. y1 and y2 are geometric representative values obtained by evaluating the worked shape, and Y1 is an example of a measurement value of a shape measurement portion at which a shape accuracy of a pressed product is required. Y1 may be set as the geometric representative value, but not limited thereto. This is because, for example, although the shape accuracy cannot be acquired when a sensitivity to the change in the material characteristic value is small at a shape assumption portion in which the shape accuracy is required, it is possible to use a measurement instrument that is simpler but inferior in measurement accuracy when the geometric representative value is measured using a portion in which the sensitivity to the change in the material characteristic value is large.

### <<Description of Flowchart>>

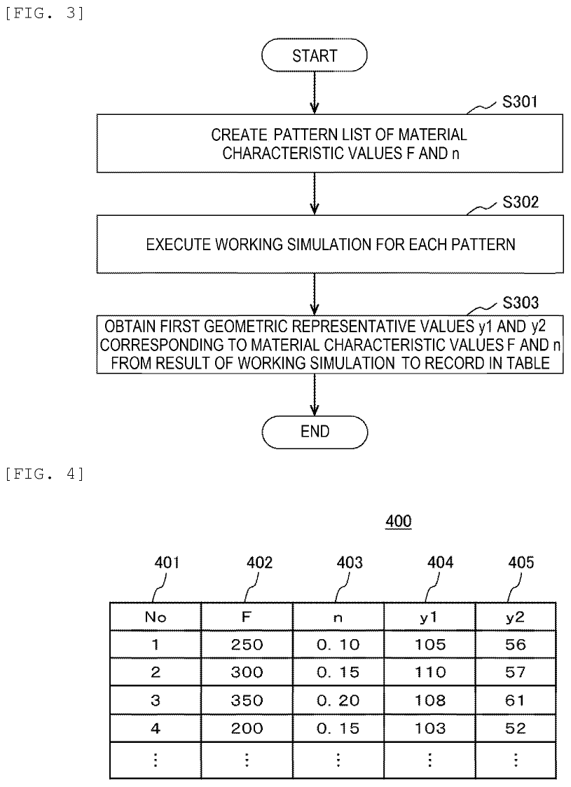

FIG. 2 is a flowchart for calculating material characteristic values and a variation thereof according to Embodiment 1 of the invention. First, correlation data between a material characteristic value and a first representative value of working information obtained by simulation based on the characteristic value is created for a workpiece whose material characteristic value (for example, Young's modulus) is already known in S201 (material in which the characteristic value is known).

Next, in a working process in S202, a workpiece whose material characteristic value is unknown (material whose characteristic value is unknown) and that is formed of the same material as the workpiece whose characteristic value used in the simulation is known is worked on, and a second representative value is acquired from working information. Further, in S203, using the correlation data created in S201 and the second representative value measured in S202, the characteristic value of the workpiece whose material characteristic value is unknown (material whose characteristic value is unknown) in S202 is calculated.

Processing of S202 and S203 is repeated until the number of samples in which the material characteristic value is measured reaches a preset number (NO in S204). After calculating the respective characteristic values for the set number of samples (YES in S204), a procedure proceeds to S205, and variation data of the material characteristic values is created.

Here, the workpiece (material whose characteristic value is known) related to the creation of the first representative value and the workpiece (material whose material is unknown) related to the acquisition of the second representative value are formed of the same material in terms of specifications (for example, a catalog specification or a material composition). For example, in a group of workpieces supplied to a material manufacturer by specifying a specification of “SUS304 having a thickness of 1.5 mm”, the workpiece whose thickness and Young's modulus are measured in advance is the workpiece (the material whose characteristic value is known), and the workpiece whose thickness and Young's modulus are not measured in advance is a comparative material (the material whose characteristic value is unknown). Other cases of materials that are the same in terms of specifications will be described later. As a condition to which the present embodiment is applied, it is unnecessary that the above “specifications” are the same, and the invention may be applied to materials that are considered to be the same as general wisdom of the market. When the workpiece is wood, it is also possible to use, for example, a workpiece which is simply specified by a type of the wood such as “mahogany”.

### <<Description of Steps in FIG. 2 Using Example in FIGS. 1A to 1C>>

Hereinafter, for the press working process in FIGS. 1A to 1C, steps of a method for calculating the material characteristic value and the variation in the material characteristic values of the workpiece whose material characteristic value is unknown will be described. It is assumed that the material characteristic value to be calculated is material constants F and n of an expression (equation 1) representing a relation between a stress σ and a strain ε, and that a correlation between the stress and the strain of the material can be experimentally approximated by the expression (equation 1).

σ=F×εⁿ (equation 1)

### <<<Method of Setting Geometric Representative Value Performed Before S201>>>

First, before S201 is performed, first geometric representative values y1 and y2 are set as the first representative values. Here, the first geometric representative values y1 and y2 are dimensions after the spring back at a position shown in FIG. 1C, and are values evaluated by the working shape of the workpiece whose material characteristic value is known. Next, second geometric representative values y1′ and y2′ are set as the second representative values. Here, the second geometric representative values y1′ and y2′ are the dimensions of positions of y1 and y2 after the spring back shown in FIG. 1C, and are values evaluated by the working shape of the workpiece whose material characteristic value is unknown.

Here, the first geometric representative values and the second geometric representative values are values measured in accordance with a common measurement condition (what kind of geometric value is measured and what portion of the workpiece is measured as a representative portion). When y1 in FIG. 1C is taken as an example, the measurement condition can be said to be that “the type of the geometric value is a length, and the representative portion is between two end surfaces in an X-axis direction of the workpiece”. When y2 in FIG. 1C is taken as an example, the measurement condition can be said to be that “the type of the geometric value is the length, and the representative portion is a depth of a recess in a Y-axis direction of the workpiece (the end surface in the X-axis direction)”. When the geometric representative value is the “length”, it is considered to use the measurement instrument or a device such as a vernier caliper and a micrometer, and the geometric representative value may be acquired by another method. When the method is performed by a computer, it may mean that the computer obtains measurement data by the measurement instrument or the device.

### <<<Details of S201: Correlation Data Creation Method>>>

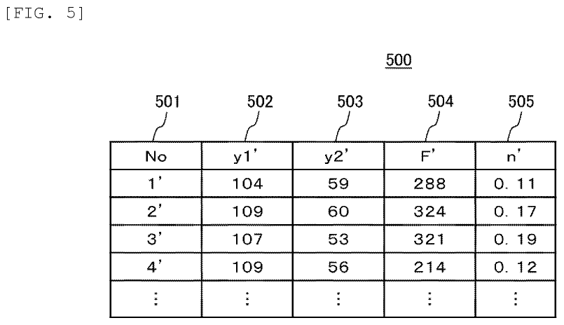

FIG. 3 shows an example of a method of creating correlation data in S201 in FIG. 2. FIG. 4 shows an example of the correlation data. A table 400 shown in FIG. 4 shows a relation among the material characteristic value F 402, the material characteristic value n 403, and the first geometric representative values y1 404 and y2 406 obtained for a plurality of samples 401. The table 400 of FIG. 4 imitates a list of patterns of material characteristic values F 402 and n 403 and the correlation data in which the first geometric representative values y1 404 and y2 405 corresponding thereto are recorded.

When numerical data as shown in the table 400 in FIG. 4 is created by, for example, a working simulation that simulates a working process by a finite element analysis, the numerical data is created in the following procedure of steps S301 to S303 as shown in a flowchart in FIG. 3.

In S301, the list of the patterns of the material characteristic values F 402 and n 403 is created by a method such as an experimental design method.

In S302, a working simulation for the press working process and the spring back process is executed under each condition of the created list of the patterns of the material characteristic values F 402 and n 403 (working simulation related to the workpiece whose material characteristic value is known).

In S303, the first geometric representative values y1 404 and y2 405 of the working shape obtained by the working simulation are evaluated and recorded in the table.

In S301, an upper limit value and a lower limit value of the material characteristic values F 402 and n 403 necessary for creating the list may be set to values F0+dF, F0−dF, n+dn, and n−dn obtained by examining average values F0 and n0 from document values of a target material and adding any widths±dF and ±dn to the average values. Alternatively, the upper limit value and the lower limit value may be set to any values larger than generally conceivable values. The list may be created by other methods, and for example, may be created by randomly changing values.

Correlation data represented by a table format can be created by the above processing, and correlation data represented by a relational expression may be constructed from the correlation data in the table format. For example, the correlation data may be constructed by approximating the values in the table 400 in FIG. 4 to relational expressions of expressions (equation 2) and (equation 3).

y1=a1×F+b1×n+c1 (equation 2)

y2=a2×F+b2×n+c2 (equation 3)

Here, a1 to c1 and a2 to c2 are constants of approximate expressions. The relational expression is not limited to the above, and approximation using quadratic function approximation, logarithmic approximation, machine learning, or the like may be used. By creating the correlation data of the relational expression, it is possible to estimate the corresponding first geometric representative values y1 404 and y2 405 of the working shape for values other than the material characteristic values F 402 and n 403 studied in the Table 400 in FIG. 4.

As described above, the “correlation data” in the present description does not exclude embodiments expressed by the expressions. This is because, in these expressions, coefficients of the expressions are provided as data, and when a plurality of approximate expressions are used, information indicating which approximate expression is used may also be provided as data.

In other words, the table 400 can be said to be data in which a correlation between a material characteristic pattern and the first geometric representative value obtained by the pattern is discretely stored.

### <<<Details of S202: Measurement for Representative Values of Workpiece Whose Material Characteristic Values are Unknown>>>

A method of measuring the second geometric representative values y1′ and y2′ in S202 in FIG. 2 will be described. A workpiece whose material characteristic value is unknown and for which the material characteristic values F and n are desired to be estimated is worked on in the press working process by an actual press machine. The second geometric representative values y1′ and y2′ are measured for the working shape after the spring back. A measurement portion definition standard for measuring the second geometric representative value is the same as a measurement portion definition standard for the first geometric representative value as described above.

### <<<Details of S203: Calculation for Material Characteristic Values of Workpiece Whose Material Characteristic Values are Unknown>>>

A calculation method for the material characteristic values F and n in S203 in FIG. 2 will be described. For example, in a case of an example in which the material characteristic values F′ and n′ of the workpiece whose material characteristic values F and n are unknown are calculated using the expressions (equation 2) and the expression (equation 3) which are the relational expressions created in S201 in FIG. 2 and the second geometric representative values y1′ and y2′ which are measured in S202 in FIG. 2, the material characteristic values F′ and n′ are obtained by substituting y1′ and y2′ into y1 and y2 in the relational expressions of expression (equation 2) and expression (equation 3) and solving simultaneous equations.

For example, in a case of an example in which the material characteristic values F′ and n′ of the workpiece whose material characteristic values are unknown are calculated using the table 400 in FIG. 4 created in S201 in FIG. 2 and the second geometric representative values y1′ and y2′ measured in S202 in FIG. 2, a combination of y1 and y2 closest to the second geometric representative values y1′ and y2′ is obtained by being searched from the table 400 in FIG. 4. The calculation method is not limited to these methods, and for example, solutions of the expression (equation 2) and the expression (equation 3) into which the second geometric representative values y1′ and y2′ are substituted may be obtained by an optimization program. Through the processing of S201 to S203 in FIG. 2, it is possible to calculate the material characteristic value of the workpiece whose material characteristic value is unknown.

### <<<Details of S205: Creation of Variation Data of Material Characteristic Values>>>

A creation example of the variation data of the characteristic values of a plurality of workpieces having basically the same composition created in S205 in FIG. 2 will be described. A table 500 in FIG. 5 shows a table that simulates the variation data. As shown in the table 500 in FIG. 5, when operations of S202 and S203 in FIG. 2 are repeated for the plurality of workpieces having unknown material characteristic values and having basically the same composition, the second geometric representative values y1′ 502 and y2′ 503 of each workpiece 501 worked on by an actual machine and the material characteristic values F′ and n′ calculated for each workpiece are obtained.

In the table 500 in FIG. 5, a list of the material characteristic values F′ 504 and n′ 505 is data indicating the variation of the material characteristic value for each workpiece 501, and it is possible to confirm to what extent the material characteristic values F′ 504 and n′ 505 vary by evaluating these pieces of data.

As a method for confirming the variation of the material characteristic values F′ and n′, for example, a distribution diagram may be created for the material characteristic values F′ 504 and n′ 505, or an average value or a standard deviation of the material characteristic values F′ 504 and n′ 505 may be calculated from the result of the table. A probability density function f (F′, n′) may be created by approximating to the result of the table 500.

As described above, it is possible to calculate the material characteristic value of the workpiece whose material characteristic value is unknown and the variation data of the material characteristic value.

Various modifications can be considered in Embodiment 1. As one modification, an example in which the table 400 in FIG. 4 is experimentally created is given. When the table 400 in FIG. 4 is experimentally created, first, the material characteristic values F 402 and n 403 are obtained in advance by a basic test, and the workpiece whose material characteristic value is known is prepared. Next, the workpiece whose material characteristic value is known is worked on by the actual press machine, and the first geometric representative values y1 404 and y2 405 of the working shape are measured to create the table 400 in FIG. 4.

When the table 400 is experimentally created, it is desired that a range of the first geometric representative values y1 404 and y2 405 in the table 400 in FIG. 4 is larger than a range of the second geometric representative values y1′ 502 and y2′ 503 of the worked shape of the workpiece whose material characteristic value is unknown. By widening the range of the first geometric representative values y1 404 and y2 405, an estimation accuracy of the material characteristic values F′ 504 and n′ 505 of the workpiece whose material characteristic value is unknown can be increased.

According to the present embodiment, it is possible to accurately estimate the material characteristic value from the working information in the working process for the workpiece whose material characteristic value is unknown. Since the basic test of the material characteristic value represented by ISO 6892 or the like requires time, it is not practical to apply the basic test to each workpiece to obtain the variation. According to the present embodiment, since the material characteristic value is identified while performing the working process in an initial period, the number of basic tests can be reduced. From another viewpoint, it can be said that a material variation can be identified while continuing the working for the workpiece by an actual working process.

### Embodiment 2

Embodiment 2 describes an example of obtaining a selection guideline of a material manufacturer that provides a workpiece using Embodiment 1.

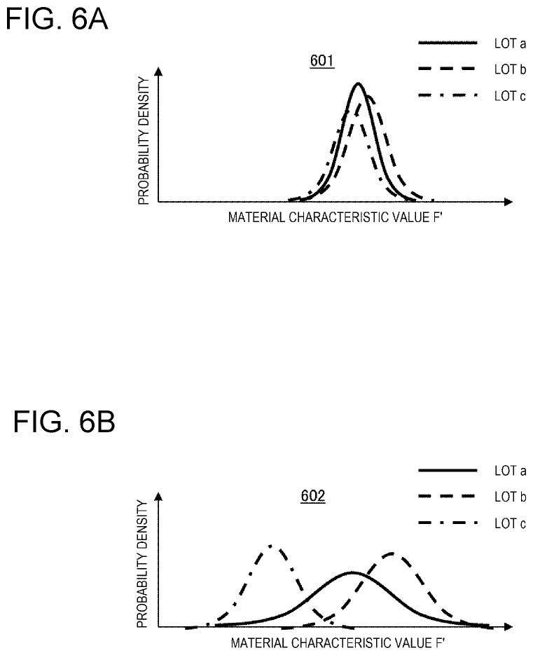

FIGS. 6A and 6B are examples in which the processing of calculating the variation in the material characteristic values according to Embodiment 1 is performed on a plurality of lots, and probability density distribution of the material characteristic values is created. FIGS. 6A and 6B respectively simulates variations in the material characteristics of the workpieces provided by a material manufacturer A and a material manufacturer B. As an example of the material characteristic value, a horizontal axis in FIGS. 6A and 6B represents the material characteristic value F′ (for example, a variable for defining a stress-strain curve in a plastic region of the material).

From probability density distribution 601 of the variation in the material characteristic of a plurality of workpieces having basically the same composition provided by the material manufacturer A in FIG. 6A, the material characteristic value F′ of the workpiece provided by the material manufacturer A can be evaluated as having a small variation in the lots and having no significant influence on the variation even when the lot is changed. That is, since the material manufacturer A has the small variation in the material characteristic values F′ of the plurality of workpieces having basically the same composition, it is presumed that a shape defect caused by the variation in the material characteristic values hardly occurs in the working process.

On the other hand, from probability density distribution 602 of the variation in the material characteristic of a plurality of workpieces having basically the same composition provided by the material manufacturer B in FIG. 6B, the material characteristic value F′ of the workpiece provided by the material manufacturer B can be evaluated as having a large variation in the lots and having a significant influence on the variation when the lot is changed. That is, since the material manufacturer B has the large variation in the material characteristic values F′ of the plurality of workpieces having basically the same composition, it is presumed that the shape defect caused by the variation in the material characteristic values easily occurs in the working process.

As described above, according to Embodiment 2, it is possible to obtain the selection guideline of the material manufacturer who provides the workpiece. Taking the above description as an example, it is expected that a dimensional defect of the working shape caused by the variation in the characteristic values can be reduced by working on the workpiece provided by the material manufacturer A. The selection guideline of the material manufacturer may create the probability density distribution as in the present embodiment to visually compare the workpieces, or may compare numerical information such as an average value of the variations in the material characteristic values and a standard deviation.

### Embodiment 3

Embodiment 3 describes an example in which a process condition of the press working shown in FIGS. 1A to 1C are optimized by utilizing the variation data of the material characteristic values calculated in Embodiment 1. Here, as the process condition to be optimized, a pressure P of the plate presser 107 shown in FIGS. 1A to 1C is given.

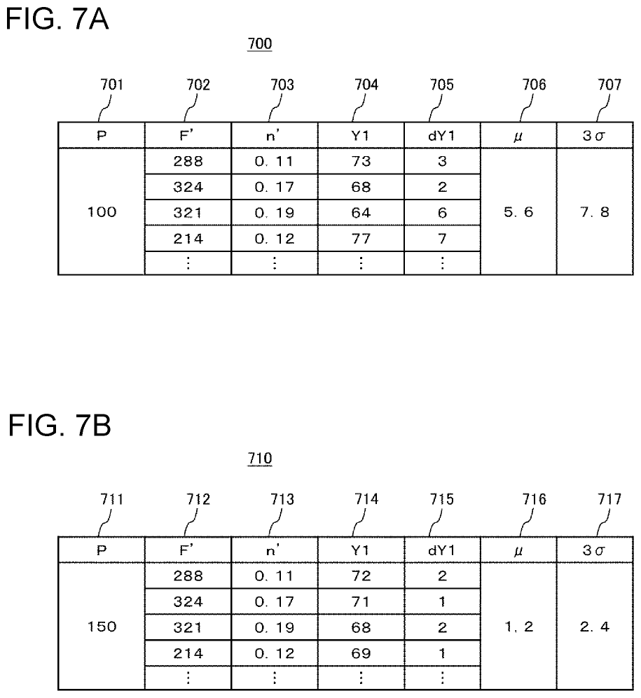

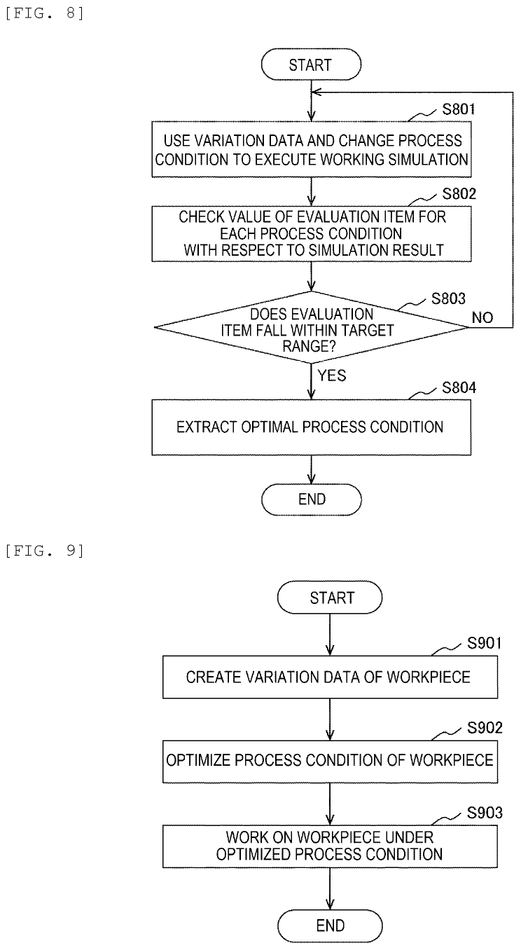

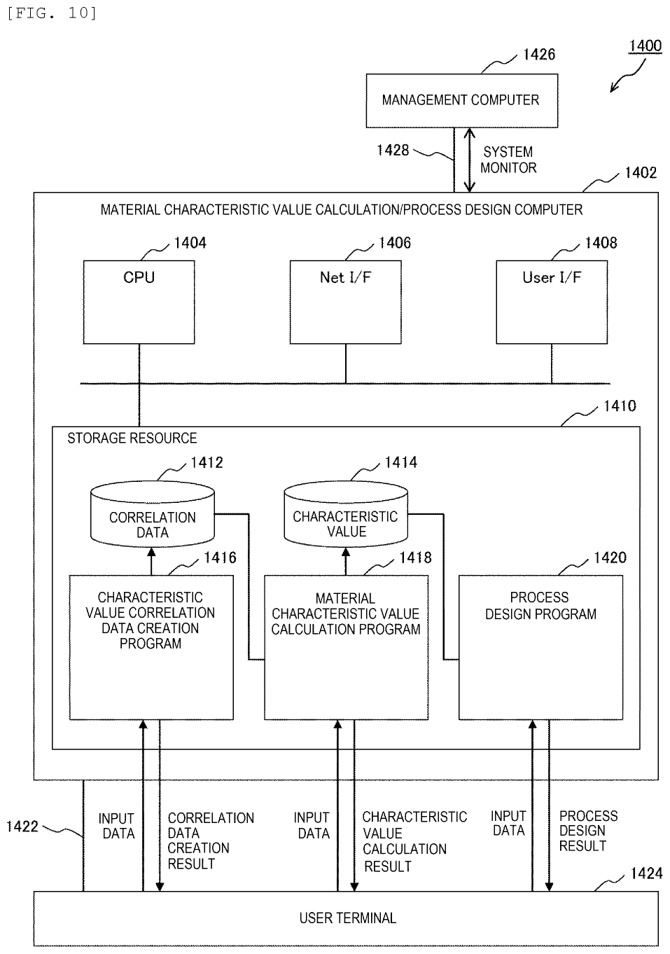

FIGS. 7A and 7B show tables that simulate a relation among pressures P 701 and 711, material characteristic values F′ 702 and 712, n′ 703 and 713, measurement values Y1 704 and 714 of a shape measurement portion at which a shape accuracy of a press product is required, absolute values dY1 705 and 715 of dimensional errors between the measurement value Y1 and a target value Y1t (a specification value of a pressed product) of the measurement value Y1, average values μ 706 and 716 of the dimensional errors dY1, and variation indexes 3σ 707 and 717 calculated by three times the standard deviation of the measurement value Y1. A table 700 in FIG. 7A and a table 710 in FIG. 7B are examples in which the pressures P 701 and 711 are temporarily set.

The material characteristic values F′ 702 and 712 and n′ 703 and 713 describe the variation data calculated in FIG. 5. The variation data in FIG. 5 may be described as it is, or a list of the material characteristic values F′ 702 and 712 and n′ 703 and 713 may be created to reproduce the probability density distribution of the probability density function f (F′, n′) approximated from the variation data.

Only a list of upper and lower limit materials of the material characteristic values F′ and n′ obtained by processing the variation data in FIG. 5 may be created. The measurement values Y1 704 and 714 can also be obtained, for example, by executing a working simulation under each condition of the pressures P 701 and 711, material characteristic values F′ 702 and 712, and n′ 703 and 713, and evaluating the working shape.

Here, comparing the table 700 in FIG. 7A with the table 710 in FIG. 7B, the average value μ 716 of the dimensional errors dY1 715 and the variation index 3σ 717 under the pressure P 711 in the table 710 of FIG. 7B are both smaller than the values in the table 700 in FIG. 7A. Accordingly, it can be determined that the pressure P 711 in the table 710 in FIG. 7B is optimal at a level of the pressure P studied in the present embodiment.

As described above, it is possible to optimize the process condition of the press working by utilizing the variation data in the material characteristic values F′ and n′ calculated based on the working shape data T1 and dY1 of the workpiece. It is possible to reduce a shape defect of a press molded article by correcting the pressure P in the actual press working to the pressure P optimized in the simulation.

The level of the pressure P may be three or more, and an optimization program may be used to obtain an optimal value of the pressure P. The measurement value Y1 may be calculated by a method other than the working simulation. The process condition to be optimized is not limited to the pressure P. For example, the press speed V shown in FIG. 1B may be set, and a workpiece temperature T1 and a die temperature T2 may be set when being present as the process condition. The number of the process conditions to be optimized may be two or more. For example, two of the pressure P and the press speed V may be set.

### <<Description of Flowchart>>

### <<<Working Process Condition Optimization>>>

FIG. 8 shows a flow of the processing for the process condition optimization described above.

First, in step S801, as described in Embodiment 1, the values in the table 500 in FIG. 5, which are created by calculating the material characteristic value of the workpiece whose material characteristic value is unknown and the variation data of the characteristic value, are used and the process condition for working on the workpiece is changed to perform the simulation.

Next, in step S802, a value of an evaluation item for each process condition obtained in step S801 is checked, and in step S803, it is checked whether the checked value of the evaluation item is within a preset target range.

As a result of the determination in step S803, when the checked evaluation item does not fall within the preset target range (NO in S803), the procedure returns to step S801, and a range is changed in which the process condition is changed to perform the working simulation again.

On the other hand, as the result of the determination in step S803, when the checked evaluation item falls within the preset target range (YES in S803), the procedure proceeds to step S804, and an optimal process condition is extracted from the checked evaluation item which falls within the preset target range.

As described above, the variation data of the material characteristic value calculated based on the working shape data of the workpiece can be used to optimize the working process condition of the workpiece by the simulation. In the embodiment described above, the working process condition optimized by changing an original working process condition is generated, and the optimized working process condition may be generated from a state in which the original working process condition is not satisfied.

### <<<Working Processing Using Working Process Condition Optimization>>>

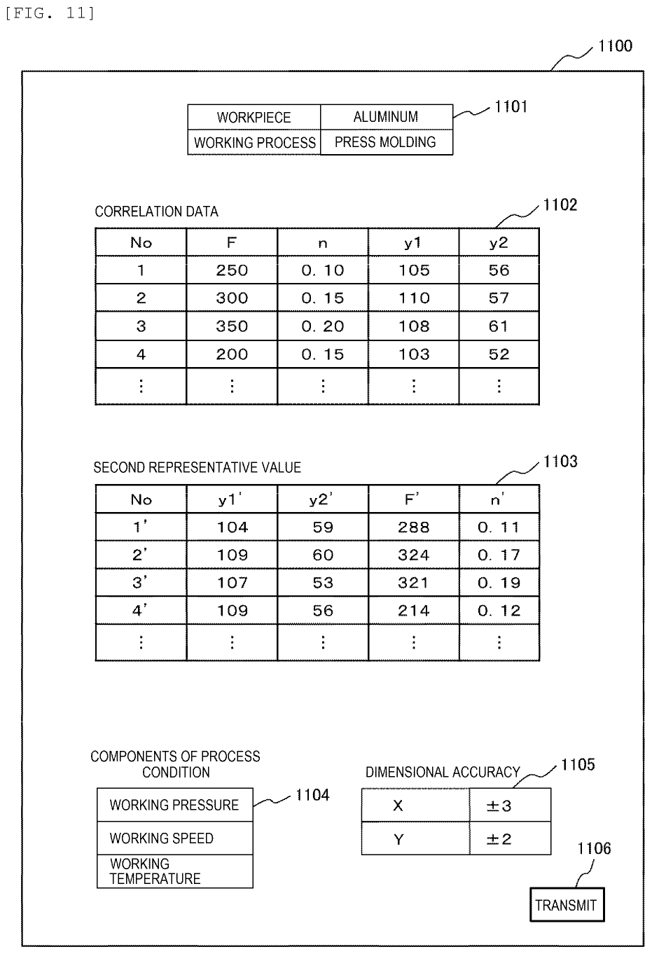

FIG. 9 shows a flow of the working processing for the workpiece according to the present embodiment.

First, in Embodiment 1, the variation data of the material characteristic value of the workpiece is created by the procedure described in the flowchart in FIG. 2, and a table as described with reference to FIG. 5 is created (S901).

Next, an optimal process condition of the workpiece is obtained by the simulation described with reference to FIG. 8 (S902), and the workpiece is actually worked on based on the obtained optimal process condition (S903).

In the present embodiment, when the process described above is applied to a press working process for a metal material, compared with a case in which press working is performed on the metal material to be worked on without obtaining the optimal process condition, it is possible to significantly reduce occurrence of the shape defect after working and to maintain a high working yield by performing press working on the metal material to be worked on based on the optimal process condition.

Though an example applied to the press working is described above, the present embodiment may be applied to optimization of a die shape in a design process. For example, the variation data may be created in advance by the method according to Embodiment 2 and used for a die design of the press working process in FIGS. 1A to 1V for a product other than the product in FIGS. 1A to 1C. The optimal process condition includes, for example, a width x of the die which is an example of the die shape parameter, and an optimal width x of the die can be selected by replacing the pressure P in Embodiment 3 with the width x of the die.

In the embodiment described above, an example is given in which two evaluation values of the index μ and 3σ related to the measurement value Y1 are reduced by optimization of the process condition. For example, when a heat generation amount of the workpiece is required, the evaluation value may be an evaluation value related to a workpiece temperature or another evaluation value. Alternatively, a working load or the like may be applied to the evaluation value when there is a request on equipment such as a reduction in the working load and a reduction in the variation.

In the embodiment described above, the example of the press working process and the example of the die working process are given, and another working process may be used. For example, forging, rolling, or machining, which is an example of the working method, may be used. In these cases, similarly to the press working, examples of the first representative value and the second representative value include the working load, the geometric dimension of the workpiece, and a heat generation amount of the workpiece. Examples of the evaluation value for determining the optimal process condition include a dimensional accuracy of the working shape, the working load, and the heat generation amount of the workpiece.

According to the present embodiment, by working on the workpiece using the optimal working process condition for the workpiece obtained by the simulation, the occurrence of the working defect can be reduced, and a manufacturing cost can be reduced.

### Embodiment 4

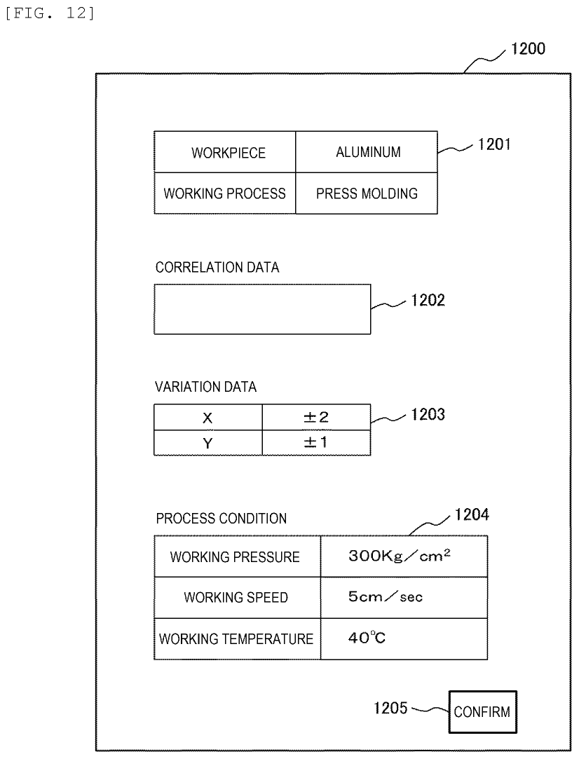

In Embodiment 4, a configuration of a computer system including a process design computer for obtaining optimal working process conditions as described in Embodiments 1 to 3 will be described with reference to FIGS. 10 to 13.

A computer system 1400 shown in FIG. 10 includes a material characteristic value calculation/process design computer 1402 as an example of a computer for the calculation of the material characteristic value and the variation data thereof and the optimization of the process condition, a management computer 1426, and one or more user terminals 1424.

The material characteristic value calculation/process design computer 1402 and the management computer 1426 are connected via a network 1428. The material characteristic value calculation/process design computer 1402 and the user terminal 1424 are connected via a network 1422. The network 1422 and the network 1428 may be a local area network (LAN) or a wide area network (WAN).

The management computer 1426 is a computer used by a system administrator of the material characteristic value calculation/process design computer 1402. The system administrator uses the management computer 1426 to monitor a storage medium capacity of the material characteristic value calculation/process design computer 1402, a utilization rate of each user, and the like to perform service operation.

The user terminal 1424 is a computer used by the user who uses the material characteristic value calculation/process design computer 1402. The user terminal 1424 includes a processor, a memory, and an interface (IF) for input by and output to the user.

The user terminal 1424 accesses the material characteristic value calculation/process design computer 1402, and inputs, for example, data such as correlation data 1102 between the representative value of the characteristic value and the first representative value at the time of working, a second representative value 1103 obtained from the working information obtained by working on the workpiece whose characteristic value is unknown, a component of a process condition 1104, a portion requiring the dimensional accuracy and a required dimensional accuracy 1105 thereof, for the workpiece whose characteristic value is known, corresponding to the material of the workpiece and a working process 1101, via an input screen (graphic user interface (GUI): hereinafter, referred to as an input GUI screen) 1100 as shown in FIG. 11.

After the input on the input GUI screen 1100 is completed, a transmission button 1106 is clicked on the screen to transmit input data to the material characteristic value calculation/process design computer 1402.

Accordingly, a condition input by the user is stored in a storage resource 1410 of the material characteristic value calculation/process design computer 1402, and the material characteristic value calculation/process design computer 1402 transmits a creation result of the correlation data between the material characteristic value and the first geometric representative value, the calculation result of the material characteristic value, and a process design result to the user terminal 1424 based on the stored data.

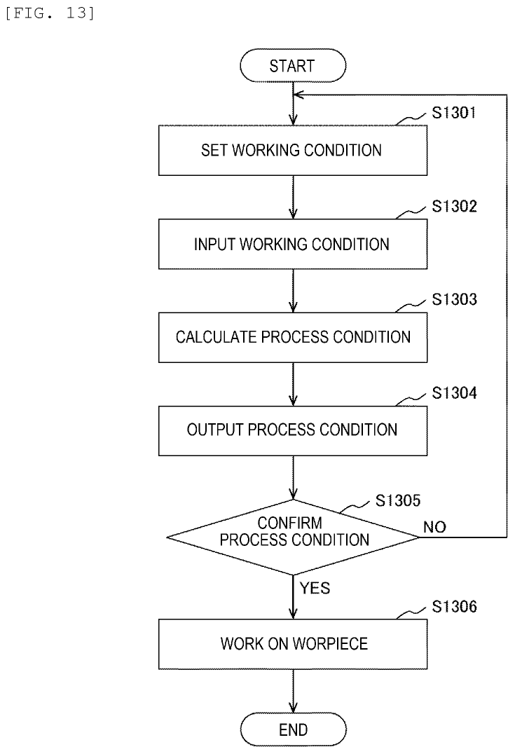

Accordingly, on an output GUI screen 1200 for outputting the calculation result as shown in FIG. 12, the user can view creation results of correlation data 1202, variation data 1203, a process condition 1204, and the like by the material characteristic value calculation/process design computer 1402 corresponding to a material of a workpiece and a working process 1201. By clicking a confirmation button 1205 on the output GUI screen 1200, the data is determined and the process condition is determined.

By working on the workpiece based on the determined process condition, the workpiece can be worked into a shape having a small dimensional variation.

The material characteristic value calculation/process design computer 1402 is, for example, a personal computer or a general-purpose computer. The material characteristic value calculation/process design computer 1402 includes a CPU 1404 as an example of the processor, a network interface 1406 (abbreviated as Net I/F in the drawing), a user interface 1408 (User I/F in the drawing), the storage resource 1410 as an example of a storage unit, and an internal network for connecting these components.

The CPU 1404 can execute a program stored in the storage resource 1410. The storage resource 1410 stores the program to be executed by the CPU 1404 and various kinds of information to be used in the program. In the present embodiment, the storage resource 1410 stores a characteristic value correlation data creation program 1416, a material characteristic value calculation program 1418, and a process design program 1420. The storage resource 1410 may be, for example, a semiconductor memory, a flash memory, a hard disk drive (HDD), or solid state drive (SSD), and may be a volatile type memory or a non-volatile type memory.

When the working simulation is executed by the characteristic value correlation data creation program 1416 or the process design program 1420, the storage resource 1410 stores CAD data indicating a shape and a target shape of the workpiece, a calculation execution condition, a working simulation software, a result file thereof and the like as input data of the process design program 1420.

The storage resource 1410 stores correlation data 1412 created by the characteristic value correlation data creation program 1416 and a characteristic value 1414 created by the material characteristic value calculation program 1418. The correlation data 1412 and the characteristic value 1414 are stored as a text file or an image file such as a graph.

The network interface 1406 is an interface for communicating with an external device (for example, the management computer 1426 and the user terminal 1424) via the network 1428 and the network 1422.

The user terminal 1424 is, for example, a touch panel, a display, a keyboard, and a mouse, and may be another device as long as the device can receive an operation from an operator (user) and display information. The user terminal 1424 may be implemented by these devices.

The characteristic value correlation data creation program 1416 receives, for example, information such as the material characteristic values F 402 and n 403 in the table 400 described with reference to FIG. 4 via the user terminal 1424, and creates the correlation data 1412 that includes the material characteristic values and the first geometric representative values (corresponding to the first geometric representative values y1 404 and y2 405 in FIG. 4) (the table 400 in FIG. 4).

Alternatively, only the material characteristic values may be received via the user terminal 1424, the first representative value may be calculated by the working simulation or the like, and the correlation data 1412 may be created. The created correlation data 1412 (corresponding to the correlation data 1102 in FIG. 11) may be transmitted to the user terminal 1424 and output to the user terminal (output GUI screen 1200 in FIG. 12).

The material characteristic value calculation program 1418 calculates, for example, the characteristic value 1414 from the correlation data 1412 created in the characteristic value correlation data creation program 1416 and the second representative value received via the user terminal 1424. Alternatively, both the correlation data 1412 and the second representative value may be received via the user terminal 1424 to create the characteristic value 1414. The created characteristic value 1414 may be transmitted to the user terminal 1424 and output to a user interface (corresponding to the output GUI screen 1200 in FIG. 12).

The characteristic value 1414 may be a value of a single material characteristic value for a single workpiece or may be variation data of material characteristic values for a plurality of workpieces. The characteristic value 1414 may be the variation data to which information indicating a lot and a material manufacturer is known.

The process design program 1420 determines an optimal process condition based on, for example, the characteristic value 1414 created in the material characteristic value calculation program 1418, a component of the process condition received via the user interface (input GUI screen 1100 in FIG. 11) of the user terminal 1424, the portion requiring the dimensional accuracy, and a required accuracy. Alternatively, both the characteristic value 1414 and other conditions may be received via the user terminal 1424 to determine the optimal process condition.

The flow of a series of processing described above will be described with reference to FIG. 13. First, in S1301, a working condition is set on the input GUI screen 1100 of the user terminal 1424 described with reference to FIG. 11 (S1301). Next, the working condition set on the input GUI screen 1100 is input to the material characteristic value calculation/process design computer 1402 via the network 1422 (S1302).

In the material characteristic value calculation/process design computer 1402 to which the working condition is input, the correlation data between the material characteristic value and the first geometric representative value is created and the material characteristic value is calculated, and the process condition is calculated based on these calculation results (S1303).

Next, the material characteristic value calculation/process design computer 1402 outputs the correlation data between the material characteristic value and the first geometric representative value, the material characteristic value, and the process condition which are obtained by performing a series of calculations to the output GUI screen 1200 of the user terminal 1424 via the network 1422 (S1304).

The user confirms the process condition displayed on the output GUI screen 1200 (S1305), and when it is determined that the dimensional accuracy 1105 falls within an allowable range (Yes in S1305), the user works on the workpiece under the displayed process condition (S1306). On the other hand, when it is determined that the dimensional accuracy 1105 under the process condition displayed on the output GUI screen 1200 does not fall within the allowable range (No in S1305), a procedure returns to S1301, and the working condition is corrected on the input GUI screen 1100.

According to the present embodiment, since it is possible to set the process condition for working on the workpiece by accurately estimating the material characteristic value from the working information in the working process for the workpiece whose material characteristic value is unknown, it is possible to work on the workpiece with good yield by reducing the variation in the shape dimension after working.

Embodiment 4 includes an example of a configuration in which the characteristic value correlation data creation program 1416, the material characteristic value calculation program 1418, and the process design program 1420 are stored in the storage resource 1410, and Embodiment 4 may be implemented by only a part of the programs. In addition, a program having a function of the material characteristic value calculation/process design computer 1402 may be stored on the user terminal and executed.

### <Modifications>

The invention is not limited to the above Embodiments 1 to 4, and includes various modifications. For example, the embodiments described above have been described in detail for easy understanding of the invention, and the invention is not necessarily limited to those including all configurations described above. A part of configurations of one embodiment can be replaced with configurations of another embodiment, and configurations of one embodiment can be added to configurations of another embodiment. A part of the configurations of each embodiment may be added to, deleted from, or replaced with another configuration. The modifications are as follows.
The working method of the workpiece may be another working method as long as a difference occurs between a shape of the workpiece during working (a shape maintained by contact with the workpiece by working equipment such as a tool or a die) and a shape of the workpiece after working (a shape of the workpiece after detachment from the working equipment). For example, in addition to the above press working, machining such as forging, rolling, cutting, drawing, and punching can be considered. Further, the working may be considered such that the shape of the workpiece after working changes depending on the material characteristic value of the workpiece. For example, resin molding can be considered.
The material of the workpiece may be a material other than a metal, and examples thereof include glass, a composite material, and a resin. However, it is preferable that the workpiece after working be an individual.
The material characteristic value of the workpiece to be identified may be a characteristic value that affects the shape of the workpiece after working, other than the above material constants F and n. For example, the material characteristic value may be a material characteristic value in an elastic region such as Young's modulus or a Poisson's ratio, and in a case of a working method in which a temperature changes due to warm forming, hot forming, friction heat generation, or the like occurs, the material characteristic value may be a thermal material characteristic, and may also be a characteristic value such as a viscosity of a material.
A type of the geometric representative value, in other words, the measurement portion definition standard described above may be other than a distance. For example, the measurement portion definition standard may be an angle or a curvature, and a thickness.
Further, in order to obtain the material characteristic value of the workpiece, a non-geometric representative value of the workpiece may be used. For example, physical property values (also including other than material physical property values) related to the workpiece during working or after working are as follows.
Temperature
Heat generation amount
Material physical property value that does not affect working, such as light transmittance and electric resistance value.
Further, the representative value may be measured for working waste separated from the workpiece during working. For example, the working waste is an end material and cutting waste that are generated by punching. Although the representative value is a representative value for a part of the workpiece immediately after the working, the representative value may also be a representative value for a member to be removed thereafter. A portion in which the working equipment fixes the workpiece by cutting and a workpiece outside the product region removed by shearing are examples.
Further, in order to obtain the material characteristic value of the workpiece, other than the workpiece, a representative value of the working equipment, a representative value of a consumable item used in the working, and a representative value related to the working waste separated from the workpiece during the working may be used. For example,
press working equipment: a feature obtained from a history of a working load (for example, maximum load)
die: a temperature of a representative position and a deformation amount during or after working
cutting tool: a temperature of a representative position and a deformation amount during or after working.

That is, it can be said that an entity (target) for measuring the representative value is a workpiece after working (material characteristic value is known), a workpiece after working (material characteristic is unknown), the working waste, the working equipment, or the consumable item.
An execution subject of the flows in Embodiments 1 to 4 can be considered to be an operator, a computer, or a combination thereof, and may use a robot.

### SUMMARY

The following content has been described in the above embodiments.

An identification method of a material characteristic value of a workpiece or a computer, the method includes:
(1) creating, with respect to a first workpiece whose material characteristic value is known, correlation data between the known material characteristic value and a first representative value of the workpiece during working or after working;
(2) working on a second workpiece whose material characteristic value is unknown;
(3) acquiring a second representative value of the second workpiece during working or after working; and
(4) acquiring a material characteristic value of the second workpiece based on the correlation data and the second representative value.
the second representative value is a value measured under the same predetermined measurement condition as the first representative value.

The measurement condition may be to measure a geometric value and a physical property value related to a predetermined portion of one or more of the following entities:
the first workpiece or the second workpiece after working,
working waste, and
working equipment or a consumable item used in the working of (2).

The creation of the correlation data of (1) may perform
(1A) creating a plurality of simulation material characteristic values based on the known material characteristic value,
(1B) executing a working simulation for simulating a working process used in the working of (2) using each of the plurality of created simulation material characteristic values, and
(1C) acquiring the first representative value based on the predetermined measurement condition from an execution result of the working simulation.

A material of the second workpiece may be the same as a material of the first workpiece in terms of specifications.

The method described above may be applied to a plurality of second workpieces to calculate a variation in material characteristic values of the second workpieces.

The variation may be calculated for each material manufacturer who provides the workpiece.

A condition of a working process of an identified second workpiece may be generated based on a material physical property value of the second workpiece, and
a third workpiece having the same specification as the first workpiece and the second workpiece may be worked on under the generated condition of the working process.

### REFERENCE SIGNS LIST

101: workpiece
103: upper die
105: lower die
107: plate presser
1100: input GUI screen
1200: output GUI screen
1400: computer system
1402: material characteristic value calculation/process design computer
1404: CPU
1410: storage resource
1416: characteristic value correlation data creation program
1418: material characteristic value calculation program
1420: process design program
1424: user terminal
1426: management computer

1. An identification method of a material characteristic value of a workpiece, the method comprising:
(1) creating, with respect to a first workpiece whose material characteristic value is known, correlation data between the known material characteristic value and a first representative value of the workpiece during working or after working;
(2) working on a second workpiece whose material characteristic value is unknown;
(3) acquiring a second representative value of the second workpiece during working or after working; and
(4) acquiring a material characteristic value of the second workpiece based on the correlation data and the second representative value, wherein
the second representative value is a value measured under the same predetermined measurement condition as the first representative value.

2. The identification method according to claim 1, wherein
the measurement condition is to measure a geometric value and a physical property value related to a predetermined portion of one or more of the following entities:
the first workpiece or the second workpiece after working,
working waste, and
working equipment or a consumable item used in the working of (2).

3. The identification method according to claim 1, wherein
the creation of the correlation data of (1) includes
(1A) creating a plurality of simulation material characteristic values based on the known material characteristic value,
(1B) executing a working simulation for simulating a working process used in the working of (2) using each of the plurality of created simulation material characteristic values, and
(1C) acquiring the first representative value based on the predetermined measurement condition from an execution result of the working simulation.

4. The identification method according to claim 1, wherein
a material of the second workpiece is the same as a material of the first workpiece in terms of specifications.

5. A variation calculation method for a material characteristic value of a workpiece, wherein
a variation in material characteristic values of a plurality of second workpieces is calculated by applying the identification method according to claim 3 to the second workpieces.

6. The variation calculation method for a material characteristic value of a workpiece according to claim 5, wherein
the variation is calculated for each material manufacturer who provides the workpiece.

7. A working method comprising:
generating a condition of a working process of the second workpiece based on a material physical property value of the second workpiece identified by the identification method of claim 1; and
working on a third workpiece having the same specification as the first workpiece and the second workpiece under the generated condition of the working process.

8. A computer comprising:
a storage resource storing correlation data; and
a processor, wherein
the correlation data indicates, with respect to a first workpiece whose material characteristic value is known, correlation between the known material characteristic value and a first representative value of the first workpiece during working or after working,
the processor
(A) receives a second representative value of a second workpiece whose material characteristic value is unknown during working or after working when the second workpiece is worked on, and
(B) acquires the material characteristic value of the second workpiece based on the correlation data and the second representative value, and
the second representative value is a value measured under the same predetermined measurement condition as the first representative value.

9. The computer according to claim 8, wherein
the measurement condition is to measure a geometric value and a physical property value related to a predetermined portion of one or more of the following entities:
the first workpiece or the second workpiece after working,
working waste, and
working equipment or a consumable item used in the working of the second workpiece.

10. The computer according to claim 8, wherein
in order to create the correlation data, the processor
creates a plurality of simulation material characteristic values based on the known material characteristic value,
executes a working simulation for simulating a working process used in the working for the second workpiece using each of the plurality of created simulation material characteristic values; and
acquiring the first representative value based on the predetermined measurement condition from an execution result of the working simulation.

11. The computer according to claim 8, wherein
a material of the second workpiece is the same as a material of the first workpiece in a specification.

12. The computer according to claim 8, wherein
the processor
acquires the material characteristic value for each of a plurality of second workpieces, and
calculates a variation in the material characteristic values of the plurality of second workpieces based on the material characteristic value for each of the second workpieces.

13. The computer according to claim 12, wherein
the variation is calculated for each material manufacturer who provides the workpiece.

14. The computer according to claim 8, wherein
the processor generates a condition of a working process of the second workpiece based on a material physical property value of the second workpiece.
